(19) United States
(12) Patent Application Publication
(10) Pub. No.: US 2010/0224315 A1
(43) Pub. Date: Sep. 9, 2010

(54) TAPE SYSTEMS FOR REFACING RACKS, SHELVES, LABELING SURFACES AND THE LIKE

(76) Inventor: Paul R. Movsesian, Barrington, RI (US)

Correspondence Address: WEINGARTEN, SCHURGIN, GAGNEBIN & LEBOVICI LLP, TEN POST OFFICE SQUARE, BOSTON, MA, 02109, US

(21) Appl. No.: 12/710,794

(22) Filed: Feb. 23, 2010

Related U.S. Application Data
(60) Provisional application No. 61/157,616, filed on Mar. 5, 2009.

(51) Int. Cl. B32B 38/10; B32B 37/00; B32B 7/12; B29C 65/50

(52) U.S. Cl. 156/249; 156/60; 428/352

(57) ABSTRACT

A system and method of refacing or resurfacing racks, shelves, labeling surfaces and the like. A tape having a release coating on one side is adhesively secured to the object surface. The tape has properties that will completely mask or “block out” any labels or markings on the rack to provide a clean and uniform surface. Pressure sensitive labels can be placed on the exposed surface of the object. These labels may contain indicia related to the assigned location of the object, product stored, safety information and the like. When the status of this information changes, the label is removed and a new label may be substituted on the object.

### CROSS REFERENCE TO RELATED APPLICATIONS

This application claims benefit of U.S. Provisional Patent Application No. 61/157,616 filed Mar. 5, 2009 entitled TAPE SYSTEMS FOR REFACING RACKS, SHELVES, LABELING SURFACES AND THE LIKE.

### STATEMENT REGARDING FEDERALLY SPONSORED RESEARCH OR DEVELOPMENT

Not applicable

### BACKGROUND OF THE INVENTION

The present application relates to a system and method of providing a clean, uniform, and reusable surface for pressure sensitive labels, and more specifically to a system and method of refacing or resurfacing rack beams, shelves, or any other such objects for subsequent labeling or relabeling of the object.

Rack beams, shelves, and other such objects frequently require a labeling or marking system to identify information such as location ID, product, pricing, safety, and general operational information. This information can change over time and therefore require relabeling or remarking to represent the new information.

In one conventional labeling system, a pressure sensitive label can be applied on top of an existing label. Oftentimes, bar codes are printed on the labels. However, the bar code on the bottom label will sometimes be visible through (or “bleed-through”) the top label and interfere with the proper scanning of the bar code on the top label.

Another conventional labeling system typically requires the removal of existing labels or markings from the rack beam, shelf, or other object to which they are applied. For example, scrapers, heat guns, and/or special solvents may be employed to clean off the labels, markings, and other residue. However, this system can be extremely messy, labor intensive, and expensive to implement.

It would therefore be desirable to have a system and method of refacing or resurfacing rack beams, shelves, and other such objects that avoid the drawbacks of the above-described conventional labeling systems.

### BRIEF SUMMARY OF THE INVENTION

In accordance with the present application, a system and method of refacing or resurfacing rack beams, shelves, and other such objects is disclosed that can be used to provide a clean, uniform, and reusable surface on such objects for pressure sensitive labels.

In one embodiment, the system includes a pressure sensitive, adhesive-backed tape having an opaque layer that serves as a masking feature, and a face with a release coating. In use, the adhesive-coated face of the tape is applied to the surface of the rack beam, shelf, or other object with the release-coated surface outermost. A printable surface layer of the tape may be colored to substantially match or contrast with the existing color of the object to which the tape is applied. The printable surface layer may also be printed to provide trademark and/or instructional information, which is visible and readable after the tape is applied to the surface. The tape can be applied by pressing the adhesive-coated surface against the face of the rack beam, shelf, or other object. This tape serves as a new face on the object to which it has been applied and provides for masking of any labels or markings underneath the tape. A label, a label holder, or other such item may then be applied to the outer face of the tape such that a pressure sensitive adhesive backing of the label is affixed to the release-coated surface of the tape, even if the label has a so-called permanent adhesive backing. When desired, the label can be easily removed and replaced with another label.

In another embodiment, a method of refacing or resurfacing a surface of a rack beam, shelf, or other object is provided for subsequent labeling or relabeling of the object. The method includes providing a tape having a lamination layer and an opaque masking layer. The lamination layer has a release-coated surface for removably receiving one or more labels and an adhesive surface, and the opaque masking layer has a non-adhesive surface and an adhesive surface. The adhesive surface of the lamination layer is adhered to the non-adhesive surface of the opaque masking layer. The method further includes applying the tape to the surface of the object by substantially permanently adhering the adhesive surface of the opaque masking layer to the object surface, thereby refacing or resurfacing the object surface. One or more labels can then be applied to and removed from the release-coated surface of the lamination layer as the tape remains substantially permanently adhered to the object surface.

According to one aspect, the object surface is a colored surface, the lamination layer is transparent, and the non-adhesive surface of the opaque masking layer is colored either substantially the same as or different from the colored object surface. The colored masking layer is visible through the transparent lamination layer of the tape. According to another aspect, the opaque masking layer is a metalized masking layer. According to still another aspect, the adhesive surface of the opaque masking layer comprises a black adhesive that serves as an additional masking feature.

In still another embodiment, a method of using a tape for refacing or resurfacing a surface of a warehouse, retail, or other storage rack or shelf is provided, in which the storage rack or shelf surface has one or more of existing labels, markings, or other indicia disposed on it. The method of this alternative embodiment includes providing a tape having a lamination layer and an opaque masking layer. The lamination layer has a release-coated surface for removably receiving one or more labels and an adhesive surface, and the opaque masking layer has a non-adhesive surface and an adhesive surface. The adhesive surface of the lamination layer is adhered to the non-adhesive surface of the opaque masking layer. The tape is applied to the surface of the storage rack or shelf to substantially cover the existing labels, markings, or other indicia disposed on the storage rack or shelf surface. Specified information is then assigned to the storage rack or shelf, and at least one label having indicia corresponding to the specified information is applied to the release-coated surface of the tape. Next, different specified information is assigned to the storage rack or shelf. The label with the indicia corresponding to the prior information is then removed, and a new label having indicia corresponding to the most recent information is applied to the release-coated surface of the tape.

In yet another embodiment, the system includes a transparent, pressure sensitive, adhesive-backed tape having a release topcoat. The tape includes a transparent laminating film with an adhesive coating on one face thereof, and a silicone release topcoat on the opposite face thereof for supporting replaceable adhesive-backed pressure sensitive labels. The transparent tape can be used to reface or resurface rack beams, shelves, etc., while allowing labels, label holders, or other such items to be applied to, removed from, and/or reapplied to the release topcoat layer of the tape.

Other features, functions, and aspects of the invention will be evident from the Detailed Description of the Invention that follows.

### BRIEF DESCRIPTION OF THE SEVERAL VIEWS OF THE DRAWINGS

The invention will be more fully understood with reference to the following Detailed Description of the Invention in conjunction with the drawings of which:

FIG. 1 is a top plan view of an exemplary self-wound tape constructed according to the present application;

FIG. 2 is a top plan view of an exemplary die cut tape constructed according to the present application;

FIG. 3 is a side elevation view of the tapes of FIGS. 1 and 2 as seen approximately from the planes indicated by A-A and B-B in FIGS. 1 and 2, respectively;

FIGS. 4a and 4b are first perspective views of a rack beam pre-labeled and post-labeled using the tape of FIG. 1 or FIG. 2;

FIGS. 5a and 5b are second perspective views of a rack beam refaced using the tape of FIG. 1 or FIG. 2;

FIG. 6 is a flow diagram illustrating a method of using the tape of FIG. 1 or FIG. 2; and

FIGS. 7a and 7b are side elevation views of exemplary alternative embodiments of the tapes of FIGS. 1 and 2 as seen approximately from the planes indicated by A-A and B-B in FIGS. 1 and 2, respectively.

### DETAILED DESCRIPTION OF THE INVENTION

The disclosure of U.S. Provisional Patent Application No. 61/157,616 filed Mar. 5, 2009 entitled TAPE SYSTEMS FOR REFACING RACKS, SHELVES, LABELING SURFACES AND THE LIKE is incorporated herein by reference in its entirety.

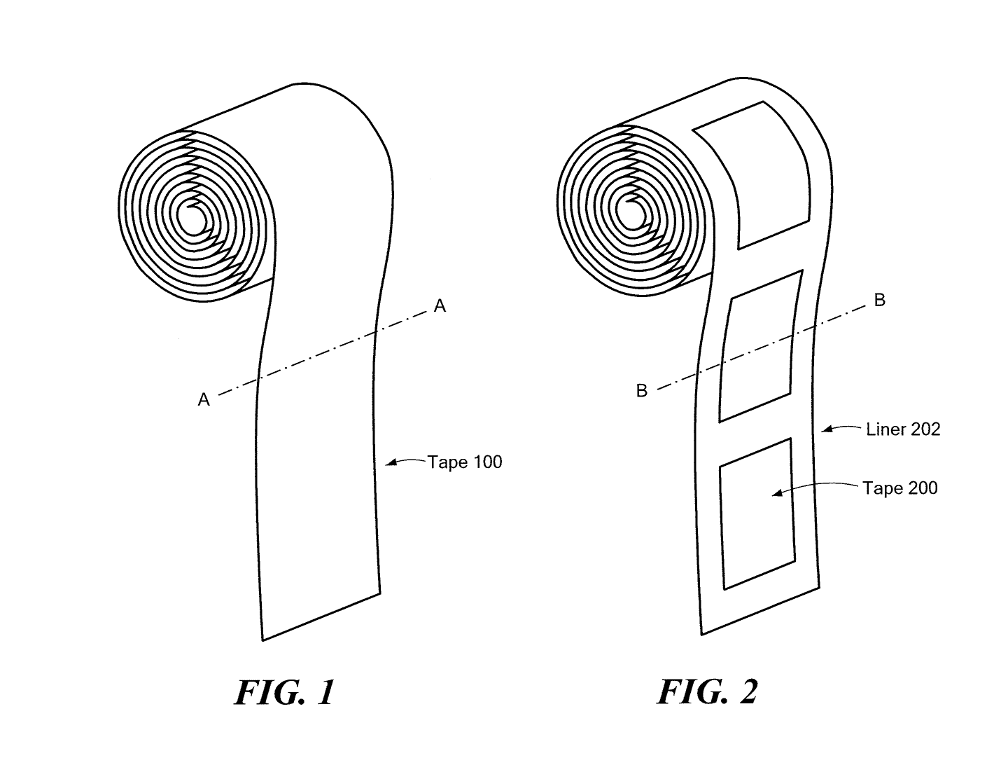

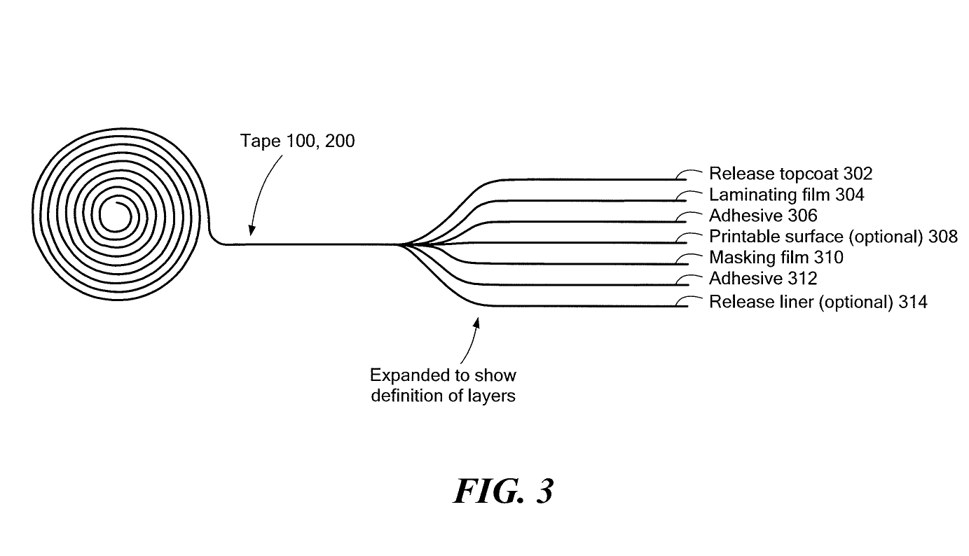

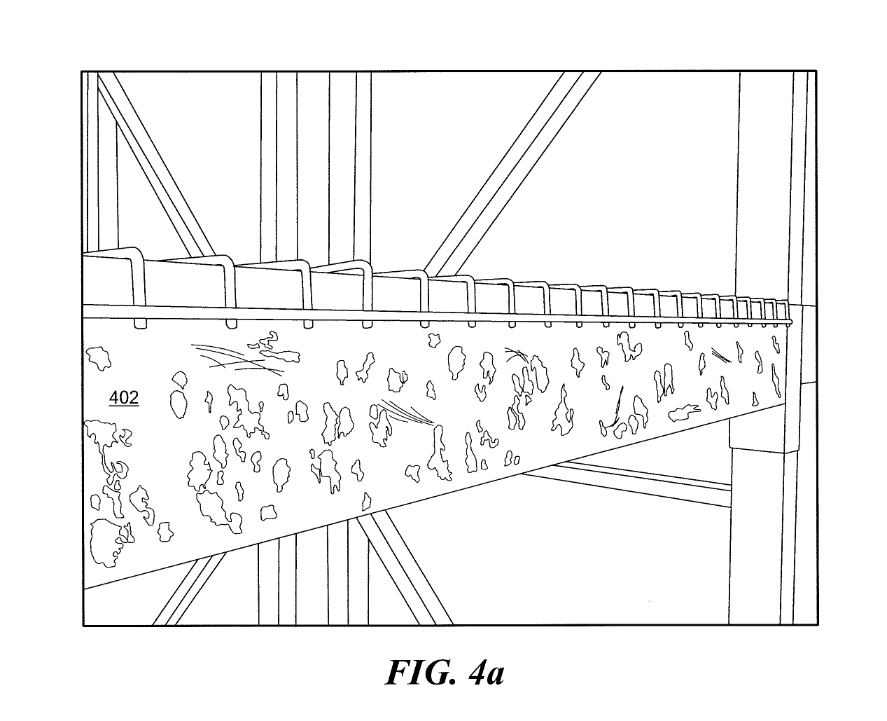

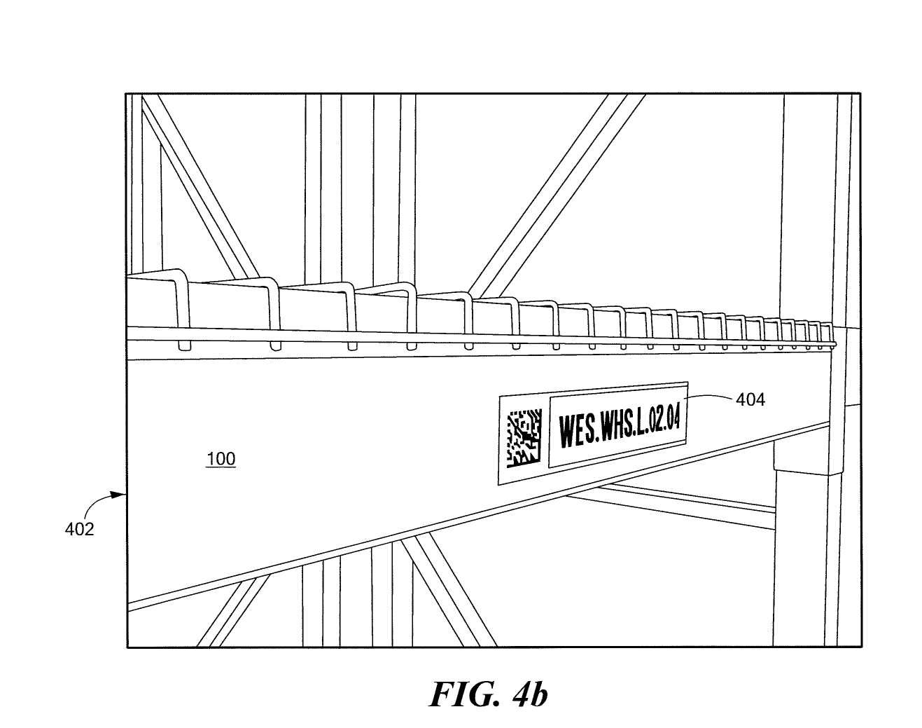

FIGS. 1 and 2 depict two illustrative embodiments of multi-layer tapes 100 and 200, respectively, in accordance with the present application. FIG. 3 depicts a detailed view of the multiple layers included in each of the tapes 100 and 200. As shown in FIG. 3, the multiple layers of each tape 100, 200 include an adhesive coating 312, a masking layer or film 310 with an optional printable surface 308, and a release topcoat 302 such as a silicone release topcoat for supporting replaceable adhesive-backed pressure sensitive labels (e.g., label 404; see FIG. 4b). More specifically, the masking layer or film can include the base masking film 310 (typically silver), the printable surface 308 (typically white) on one face of the base masking film 310, and the adhesive coating 312 on the opposite face of the base masking film 310. For example, the base masking film 310 may be a silver polyester film, a metalized masking film, a metalized biaxially-oriented polypropylene (BOPP) film, or any other suitable opaque masking film. In one embodiment, the printable surface 308, the base masking film 310, and the adhesive coating 312 are implemented using a metalized BOPP film having a print-receptive topcoat and a metalized backside. The adhesive coating 312 of the tape 200 (see FIG. 2) can be affixed to an optional release-coated liner 314, which can include a silicone release layer. In one embodiment, the adhesive coating 312 comprises a black adhesive that can also serve as a masking feature. The tape 100 of FIG. 1 is of the “self-wound” type that does not require the release-coated liner 314.

As shown in FIG. 3, the multiple layers of the tapes 100, 200 can further include a transparent laminating film 304 with an adhesive coating 306 on one face thereof and the silicone release topcoat 302 on the opposite face thereof. It is noted that the printable surface 308 may be any desired color and/or printed with a trademark(s), instructions, a logo(s), or any other suitable information, which can be viewed through the transparent laminating film 304. The adhesive face 306 of the laminating film 304 is adhered to a non-adhesive face of the printable surface 308. The tape 100 without the release liner 314 is typically self-wound on a roll, as illustrated in FIG. 1. The tape 200 can be die cut, as illustrated in FIG. 2, to remove marginal portions of the layers 302, 304, 306, 308, 310, and 312. As a result, the release liner 314 is made larger than the tape 200 to facilitate its removal.

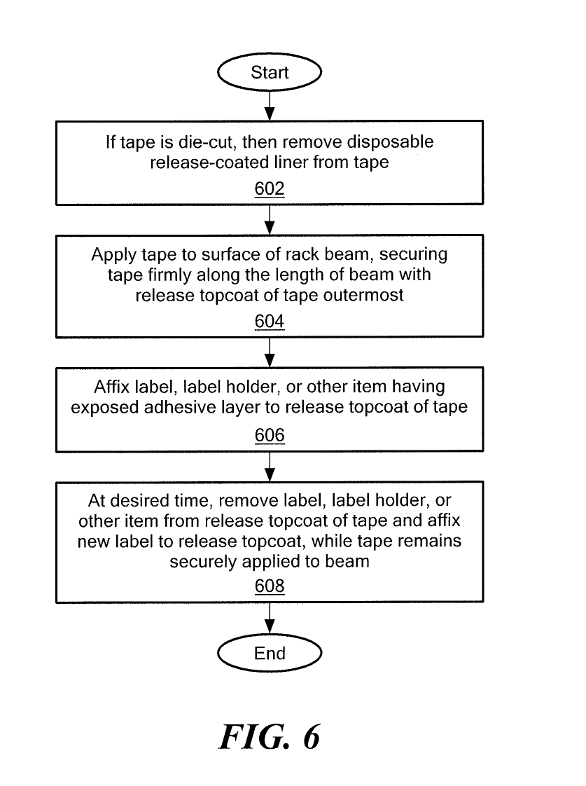

An illustrative method of using the presently disclosed tape for refacing or resurfacing rack beams, shelves, or any other suitable object or article is described below with reference to FIGS. 1, 2, 3, 4a, 4b, and 6. When using the die-cut tape 200 (see FIG. 2), the first step is to remove the disposable release-coated liner 314 (see FIG. 3) from the tape 200, as depicted in step 602 (see FIG. 6). It is noted that step 602 is not required when using the self-wound tape 100 (see FIG. 1). The tape 100 (or 200) can then be applied to a rack beam 402 (see FIGS. 4a and 4b) such that the adhesive 312 secures the tape 100 (or 200) firmly along the length of the beam surface (see FIG. 4b) with the release topcoat 302 outermost and any printing on the printable surface 308 clearly visible, as depicted in step 604. Then, a label 404 (see FIG. 4b), a label holder, or any other suitable item having an exposed adhesive layer is affixed to the tape 100 (or 200) such that the label's adhesive makes contact with the release topcoat 302, as depicted in step 606. For example, the label 404 may carry printed indicia related to the rack location ID, products stored, pricing, safety, or any other suitable information. When desired, such as when changing location specifications, the label 404 can be removed from the release topcoat 302 and a new label can be affixed to the tape 100 (or 200) on the rack beam 402, as depicted in step 608. It is further noted that when the tape 100 (or 200) is applied to the rack beam 402, any pits or pockmarks on the beam are securely covered and hidden by the tape, thereby providing a clean, smooth surface upon which any suitable label(s) may be affixed.

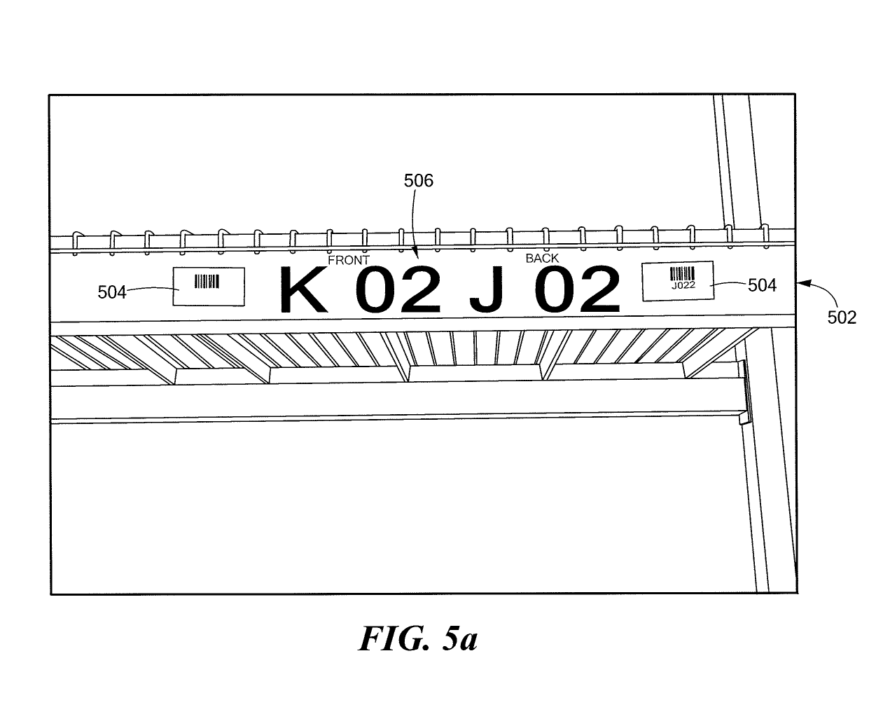

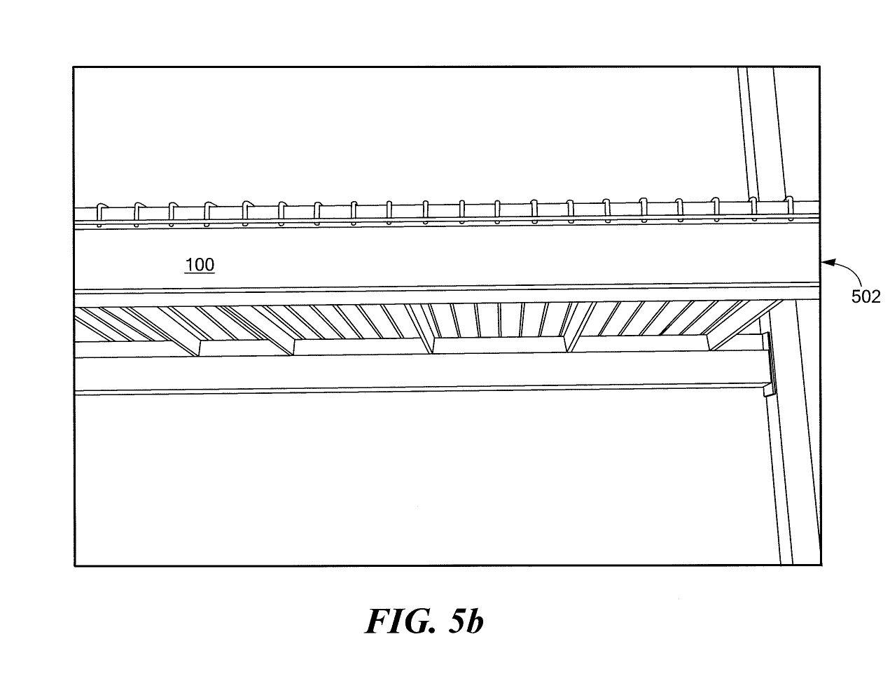

FIG. 5a depicts a rack beam 502 that has a number of existing bar code labels 504 and other labeling 506 affixed thereto. After the tape 100 (or 200) is applied to the surface of the rack beam 502, a clean, smooth labeling surface is provided that completely hides the labels 504, 506 originally affixed to the beam (see FIG. 5b), thereby obviating the need to remove the labels 504, 506 from the beam.

The presently disclosed tape systems 100, 200 allow pressure sensitive labels to be easily removed and replaced on rack beams, shelves, or any other suitable object, as many times as necessary. Such labels can be removed without ripping or tearing. Further, new labels can be applied without fear of previous labels or markings affecting the scan of a bar code. This allows rack beams and shelves to remain clean and uniform and contain only labels with the most current required data. As a result, any confusion from numerous labels with conflicting information on the rack beams or shelves is minimized. Moreover, the release topcoat 302 of the tapes 100, 200 allows any commercially available label to be used, including those with inexpensive permanent pressure sensitive adhesive coatings rather than more expensive removable coatings.

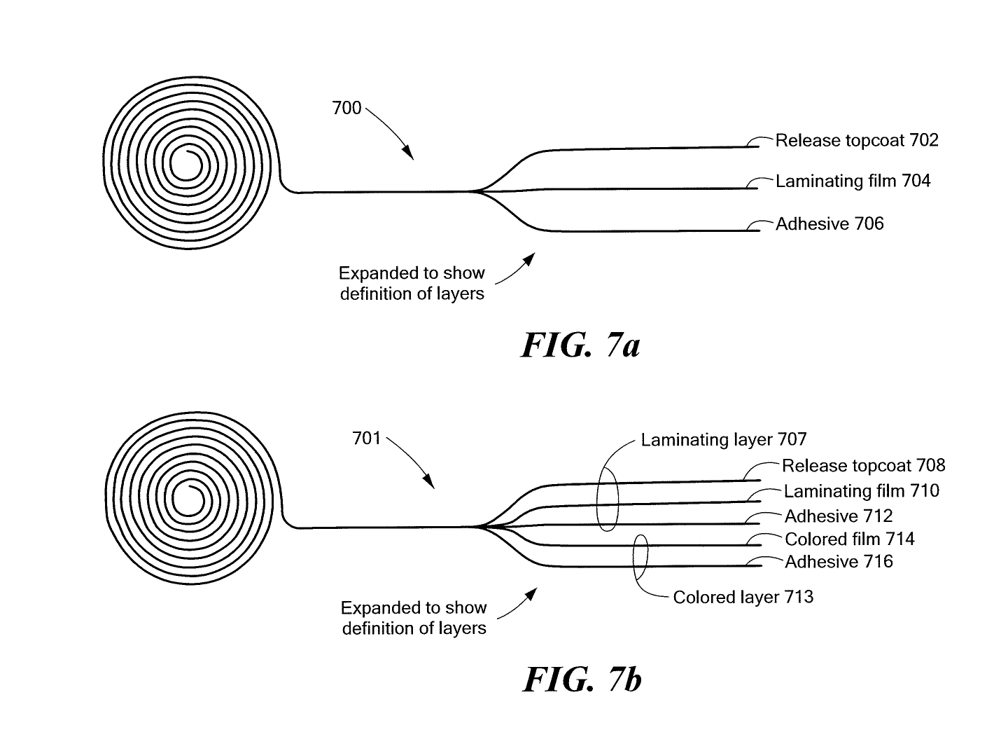

Having described the above illustrative embodiments of the presently disclosed system and method of refacing or resurfacing rack beams, shelves, and other such objects, other alternative embodiments or variations may be made. For example, FIG. 7a depicts a detailed view of multiple layers included in a first alternative embodiment 700, which is a transparent version of the tapes 100 and 200. As shown in FIG. 7a, the multiple layers of the tape 700 include a transparent laminating film 704 with an adhesive coating 706 on one face thereof, and a silicone release topcoat 702 on the opposite face thereof for supporting replaceable adhesive-backed pressure sensitive labels. The transparent tape 700 can be used to reface or resurface rack beams, shelves, or any other suitable object or article, while allowing labels, label holders, or other such items to be applied to and removed from the release topcoat layer 702 of the tape 700.

FIG. 7b depicts a detailed view of multiple layers included in a second alternative embodiment 701, which is a colored version of the tapes 100 and 200. As shown in FIG. 7b, the multiple layers of the tape 701 include a transparent lamination layer 707 and a colored layer 713. The lamination layer 707 includes a transparent laminating film 710 with an adhesive coating 712 on one face thereof, and a silicone release topcoat 708 on the opposite face thereof for supporting replaceable adhesive-backed pressure sensitive labels. The colored layer 713 includes a base colored film layer 714 with an adhesive coating 716 on one face thereof. The face of the base colored film layer 714 opposite the adhesive coating 716 is a non-adhesive face, and the adhesive layer 712 of the lamination layer 707 is applied to the non-adhesive face of the base colored film layer 714. Like the transparent tape 700, the colored tape 701 can be used to reface or resurface rack beams, shelves, or any other suitable object or article, while allowing labels, label holders, or other such items to be applied to and removed from the release topcoat layer 708 of the tape 701. Moreover, the base colored film layer 714 may be colored to substantially match or contrast with the existing color of the object to which the tape 701 is applied. For example, the base colored film layer 714 can be made using a colored base material, ink covering the base material, thermal-melted ribbon covering the base material, adhesive-backed vinyl covering the base material, a silk screen technique, an ink jet/toner technique, or any other suitable covering, coating, coloring, or printing technique, resulting in a color on the base film layer 714 that can be seen through the transparent lamination layer 707.

It will be appreciated by those of ordinary skill in the art that further modifications to and variations of the above-described tape systems for refacing racks, shelves, labeling surfaces and the like may be made without departing from the inventive concepts disclosed herein. Accordingly, the invention should not be viewed as limited except as by the scope and spirit of the appended claims.

What is claimed is:

1. A method of resurfacing a surface of an article for subsequent labeling or relabeling of the article, the method comprising the steps of:
in a providing step, providing a tape having a lamination layer and an opaque masking layer, the lamination layer having a release-coated surface for removably receiving one or more labels and an adhesive surface, the opaque masking layer having a non-adhesive surface and an adhesive surface, the adhesive surface of the lamination layer being adhered to the non-adhesive surface of the opaque masking layer; and
applying the tape to the article surface, thereby resurfacing the article surface,
wherein the applying of the tape includes substantially permanently adhering the adhesive surface of the opaque masking layer to the article surface, and
whereby, at least at some times, the one or more labels are selectively applied to and removed from the release-coated surface of the lamination layer as the tape remains substantially permanently adhered to the article surface.

2. The method of claim 1:
wherein the article surface is a colored surface; and
wherein the providing step includes providing the tape having the lamination layer and the opaque masking layer, the lamination layer being transparent, the non-adhesive surface of the opaque masking layer being colored substantially the same as the colored article surface,
whereby the colored masking layer is visible through the transparent lamination layer.

3. The method of claim 1:
wherein the article surface is a colored surface; and
wherein the providing step includes providing the tape having the lamination layer and the opaque masking layer, the lamination layer being transparent, the non-adhesive surface of the opaque masking layer being colored differently from the colored article surface,
whereby the colored masking layer is visible through the transparent lamination layer.

4. The method of claim 1:
wherein the providing step includes providing the tape having the lamination layer and the opaque masking layer, the lamination layer being transparent, the non-adhesive surface of the opaque masking layer being printable,
whereby the printable non-adhesive surface of the opaque masking layer is visible through the transparent lamination layer.

5. The method of claim 1 wherein the providing step includes providing the tape having the lamination layer and the opaque masking layer, the release-coated surface of the lamination layer comprising a silicone release coating.

6. The method of claim 1 wherein the providing step includes providing the tape having the lamination layer and the opaque masking layer, the tape further including a disposable liner covering the adhesive surface of the opaque masking layer.

7. The method of claim 6 further including removing the disposable liner from the adhesive surface of the opaque masking layer before applying the tape to the article surface.

8. The method of claim 6 wherein the providing step includes providing the tape having the lamination layer and the opaque masking layer, the tape being die-cut.

9. The method of claim 1 wherein the tape comprises a self-wound tape.

10. A method of using a tape for resurfacing a surface of a warehouse, retail, or other storage rack or shelf, the storage rack or shelf surface having one or more of existing labels, markings, or other indicia disposed thereon, the method comprising the steps of:
in a providing step, providing a tape having a lamination layer and an opaque masking layer, the lamination layer having a release-coated surface for removably receiving one or more labels and an adhesive surface, the opaque masking layer having a non-adhesive surface and an adhesive surface, the adhesive surface of the lamination layer being adhered to the non-adhesive surface of the opaque masking layer;
applying the tape to the surface of the storage rack or shelf, thereby substantially covering the existing labels, markings, or other indicia disposed on the storage rack or shelf surface;
in a first assigning step, assigning first specified information to the storage rack or shelf; and
applying at least one first label to the release-coated surface of the tape lamination layer, the first label having indicia corresponding to the first specified information assigned to the storage rack or shelf.

11. The method of claim 10 further including:
in a second assigning step, subsequently assigning second specified information to the storage rack or shelf;
removing the first label from the release-coated surface of the tape lamination layer; and
applying at least one second label to the release-coated surface of the tape lamination layer, the second label having indicia corresponding to the second specified information assigned to the storage rack or shelf.

12. The method of claim 11:
wherein the first assigning step and the second assigning step include assigning the first specified information to the storage rack or shelf and subsequently assigning the second specified information to the storage rack or shelf, respectively; and
wherein the first specified information and the second specified information include one or more of a location identifier for the storage rack or shelf, safety or security information for the storage rack or shelf, and information pertaining to a specified material to be stored on the storage rack or shelf.

13. The method of claim 10 wherein the providing step includes providing the tape having the lamination layer and the opaque masking layer, the tape further including a disposable liner covering the adhesive surface of the opaque masking layer.

14. The method of claim 13 further including removing the disposable liner from the adhesive surface of the opaque masking layer before applying the tape to the storage rack or shelf surface.

15. The method of claim 13 wherein the providing step includes providing the tape having the lamination layer and the opaque masking layer, the tape being die-cut.

16. The method of claim 10 wherein the tape comprises a self-wound tape.

17. A method of resurfacing a surface of an article, the method comprising the steps of:
in a providing step, providing a tape having a lamination layer and an opaque masking layer, the lamination layer having a release-coated surface and an adhesive surface, the opaque masking layer having a non-adhesive surface and an adhesive surface, the adhesive surface of the lamination layer being adhered to the non-adhesive surface of the opaque masking layer; and
applying the tape to the surface of the article, thereby resurfacing the article surface,
wherein the applying of the tape includes substantially permanently adhering the adhesive surface of the opaque masking layer to the article surface, and
whereby one or more of existing labels, markings, or other indicia disposed on the article surface are substantially covered and hidden by the tape when the tape is applied to the article surface.

18. The method of claim 17:
wherein the article surface is a colored surface; and
wherein the providing step includes providing the tape having the lamination layer and the opaque masking layer, the lamination layer being transparent, the non-adhesive surface of the opaque masking layer being colored substantially the same as the colored article surface,
whereby the colored masking layer is visible through the transparent lamination layer.

19. The method of claim 17:
wherein the article surface is a colored surface; and
wherein the providing step includes providing the tape having the lamination layer and the opaque masking layer, the lamination layer being transparent, the non-adhesive surface of the opaque masking layer being colored differently from the colored article surface,
whereby the colored masking layer is visible through the transparent lamination layer.

20. The method of claim 17:
wherein the providing step includes providing the tape having the lamination layer and the opaque masking layer, the tape further including a disposable liner covering the adhesive surface of the opaque masking layer, and the tape being die-cut; and
wherein the method further includes removing the disposable liner from the adhesive surface of the opaque masking layer before applying the tape to the article surface.

21. The method of claim 17 wherein the tape comprises a self-wound tape.

22. A tape for resurfacing a surface of an article, comprising:
a lamination layer having a release-coated surface and an adhesive surface; and
an opaque masking layer having a non-adhesive surface and an adhesive surface,
wherein the adhesive surface of the lamination layer is adhered to the non-adhesive surface of the opaque masking layer,
wherein the release-coated surface is operative to removably receive one or more adhesive labels applied thereto, and
wherein the adhesive surface of the opaque masking layer is operative to be substantially permanently adhered to the article surface,
whereby one or more of existing labels, markings, or other indicia disposed on the surface of the article are substantially covered and hidden by the tape when the adhesive surface of the opaque masking layer is substantially permanently adhered to the article surface.

23. A method of resurfacing a surface of an article, the method comprising the steps of:
in a providing step, providing a tape having a transparent lamination layer, the transparent lamination layer including a transparent laminating film layer having a release-coated surface and an adhesive surface; and
applying the tape to the surface of the article, thereby resurfacing the article surface,
wherein the applying of the tape includes substantially permanently adhering the adhesive surface of the transparent laminating film layer to the article surface.

24. A tape for resurfacing a surface of an article, comprising:
a transparent lamination layer including a transparent laminating film layer having a release-coated surface and an adhesive surface,
wherein the release-coated surface of the transparent laminating film layer is operative to removably receive one or more adhesive labels applied thereto, and
wherein the adhesive surface of the transparent laminating film layer is operative to be substantially permanently adhered to the article surface,
whereby the surface of the article is substantially covered by the tape when the adhesive surface of the transparent laminating film layer is substantially permanently adhered to the article surface.

25. A method of resurfacing a surface of an article, the method comprising the steps of:
in a providing step, providing a tape having a transparent lamination layer and an opaque colored layer, the transparent lamination layer including a transparent laminating film layer having a release-coated surface and an adhesive surface, the opaque colored layer including a colored film layer having a non-adhesive surface and an adhesive surface, the adhesive surface of the transparent laminating film layer being adhered to the non-adhesive surface of the opaque colored layer; and
applying the tape to the surface of the article, thereby resurfacing the article surface,
wherein the applying of the tape includes substantially permanently adhering the adhesive surface of the opaque colored layer to the article surface, and
whereby one or more of existing labels, markings, or other indicia disposed on the article surface are substantially covered by the tape when the tape is applied to the article surface.

26. The method of claim 25 wherein the opaque colored layer is made using a base material that is colored, ink covering the base material, thermal-melted ribbon covering the base material, adhesive-backed vinyl covering the base material, a silk screen technique, or an ink jet/toner technique.

27. A tape for resurfacing a surface of an article, comprising:
a transparent lamination layer including a transparent laminating film layer having a release-coated surface and an adhesive surface; and
an opaque colored layer including a colored film layer having a non-adhesive surface and an adhesive surface,
wherein the adhesive surface of the transparent laminating film layer is adhered to the non-adhesive surface of the opaque colored layer,
wherein the release-coated surface of the transparent laminating film layer is operative to removably receive one or more adhesive labels applied thereto,
wherein the adhesive surface of the opaque masking layer is operative to be substantially permanently adhered to the article surface, and
whereby one or more of existing labels, markings, or other indicia disposed on the surface of the article are substantially covered by the tape when the adhesive surface of the opaque masking layer is substantially permanently adhered to the article surface.

28. The method of claim 27 wherein the opaque colored layer is made using a base material that is colored, ink covering the base material, thermal-melted ribbon covering the base material, adhesive-backed vinyl covering the base material, a silk screen technique, or an ink jet/toner technique.
